(19) United States
(12) Patent Application Publication
(10) Pub. No.: US 2008/0044580 A1
(43) Pub. Date: Feb. 21, 2008

(54) Dressings Which Can Be Applied Several Times To Textile Fibers And Textile Fabrics

(75) Inventors: Oliver Marte, Wattwil (CH); Walter Marte, Ulisbach (CH); Stefan Angehrn, Ulisbach (CH); Martin Meyer, Thalwil (CH); Ulrich Meyer, Zurich (CH); Urs Von Arx, Huttwil (CH); Ruth Weber, Oberburg (CH); Olive Kunzi, Heimberg (CH); Cedric Clivaz, Niederwangen (CH); Martin Hochstrasser, Neuendorf (CH)

Correspondence Address: SPECKMAN LAW GROUP PLLC, 1201 THIRD AVENUE, SUITE 330, SEATTLE, WA, 98101, US

(73) Assignee: Schoeller Textil AG, Sevelen (CH)

(21) Appl. No.: 11/572,486

(22) PCT Filed: Jul. 18, 2005
(86) PCT No.: PCT/CH05/00419

§ 371 Date: Aug. 21, 2007

(30) Foreign Application Priority Data
Jul. 20, 2004 (CH) 1222/04
Oct. 29, 2004 (CH) 1797/04

(51) Int. Cl. D06M 15/37; B05D 3/02

(52) U.S. Cl. 427/394; 252/8.61; 8/115.51

(57) ABSTRACT

Formulations for dressing, dressing layers, dressed textile fibers and textile fabrics, and methods for dressing textile fibers and textile fabrics are provided. The textiles can receive, a plurality of times, active substances, or active ingredients, which can be deposited in a isotropic manner to the surrounding medium or in an anisotropic manner in a directly adjacent layer by means of a locally oriented material flow. The dressing layers are characterized by their ability to swell and to receive active substances. Polymer layers form nano pockets during swelling which can receive one or several guest molecules. The active substances can be deposited when the loaded textiles are worn and absorbed by the skin of the wearer, either cutaneously or percutaneously, to produce the desired effect.

This invention relates to finish formulations and reloadable finishes on textile fibers and fabrics, as well as to a method for applying such functional layers to textile fibers and fabrics. In like manner, this invention relates to the textile fibers and fabrics that are treated or obtained with finishes that can be repeatedly loaded based on the method according to the invention.

The market for coated or finished textiles is today probably the fastest growing market within the textile sector. Increasingly tighter requirements are being placed on the functionality of coated or finished textiles, while at the same time, tougher environmental and consumer protection laws are putting greater restrictions on the range of available chemicals. Hence, finishers are being asked to create new products that offer new and/or improved function using a limited selection of starting materials. Literature and practice describe a plurality of coatings that influence and improve the surface properties of textile fabrics in terms of dirt repulsion, water and/or oil repulsion, UV-resistance, abrasion resistance and chemical resistance. In all of these functions, the emphasis is placed on protecting the wearer of the textile product against some outside influence, i.e., keeping materials away from the body of the wearer.

The term “intelligent textiles” is a term already in use today encompassing known textiles with coatings/finishes worn close to the body, which makes it possible to provide garments with active therapeutic or cosmetic ingredients that are imparted to the skin of the wearer or released from the finish while the garments are being worn. The range of economically interesting active ingredients is conceivably large, extending from cortisone in salves for neurodermatitis patients and nicotine for weaning smokers to anti-wrinkling agents in skin creams. The continuous supply of analgesics, hormones, vitamins or sun protection to the skin via such intelligent bio-finishes has already been proposed. It is also known that antibacterial substances can be used in textiles, such as underwear, socks, sports clothing or shoes, to prevent the development of unpleasant perspiration odor.

Unless otherwise specified below, active ingredients and active substances are regarded as pharmaceuticals and wellness substances. Pharmaceutical law defines the former as substances and compositions of substances that are applied to or in the human or animal body to heal, ease, prevent or detect illness, pain, bodily injury or disease symptoms. Wellness substances are substances used to enhance the sense of overall well being in all physical and mental aspects of life, and bring the mind, body and spirit in harmony with nature. Wellness substances are also to be understood as cosmetics in the following. Several pharmaceutically active substances from both “natural medicine” and traditional medicine to be included among pharmaceuticals based on the above categorization are summarized below, along with their respective applications:

Motion sickness: Scopolamine, cinnarizine, meclozine;

Smoking cessation: Nicotine;

Vein problems: Heparin;

Hay fever: Antihistamines, including cetirizine;

Muscle/joint pain: Diclofenac; and

Angina pectoris: Glycerol trinitrate

There are essentially two different ways of manufacturing intelligent finishes in textile finishing. On the one hand, loadable cage molecules, e.g., cyclodextrins or dendrimers, are applied to the surfaces to be coated, or polymer binder systems (e.g., polyacrylates or polymethanes) mixed with the respective active ingredients are applied to the textile substrate. The layers functionalized with the cage molecules can be repeatedly loaded, as opposed to the layers in which the coating substance consists of a prefabricated mixture of polymer binders and active substances, and is applied as the finish during the course of fabric finishing. Both cited manufacturing methods are associated with disadvantages relating primarily to the target application, specifically to the functionality of the finish layers to be manufactured.

The range of application for the layers manufactured with cage molecules is greatly limited by the molecular size and geometry, as well as by the affinity to the substances to be incorporated, which can only be set within very narrow limits. The cyclodextrins, for example, are oligosaccharides comprised of 6 to 8 glucose units with a hollow structure having the polar OH groups on the outside and a hydrophobic interior. As a consequence, only small lipophilic active substances can be incorporated, thereby imposing major constraints on the objectives and universality of cyclodextrin-containing finishes. As a result, cage molecules usually already loaded with active substances are mixed in with the finishing liquors, and applied to the fabric by the textile finisher. Given the resultant functionality and predetermined intended application of such finished fabrics, only very limited quantities are manufactured to hold down the sales risk. This makes the products very expensive, and the product range stays small. The advantage to layers manufactured with “cage molecules” in comparison to polymer binder systems has to do with their reloadability after the garment in question has been washed, which depends in part upon the used finishing agents.

This reloadability is not provided during the application of polymer binder systems mixed directly with active substances. The functionality-determining chemicals or active ingredients are here applied to the textile article during the finishing process, and then most often thermally fixed. A large portion of the target function is already lost during this fixation process. Among other things, the active ingredients are thermally decomposed, or altered, bound or decomposed by reacting with the fixation means, or they evaporate and are dissipated with the heating medium (e.g., with the outgoing air). The residual active substance remaining on the fabric determines the functionality for only a limited period of use for the respective garment, since wellness layers fabricated in this way are not wash resistant, and cannot be reloaded. As a result of the described disadvantages, the market for fabric functionalized in this way is very limited, and the sales risk to the textile finisher is high.

The object of the invention is to provide finish formulations, reloadable finishes, finished textile fibers and fabrics, and methods for finishing textile fibers and fabrics, which are not associated with the disadvantages inherent in the products and methods available on the textile market.

This object is achieved using new finish formulations, new finish methods, new finishes, and textile fibers and fabrics treated with the new finishes. Specially selected chemicals, some of which are unusual for use in the textile industry, make it possible to achieve the following, among other things:
i) the new finishes can be multiply loaded, e.g., after prolonged use or after a corresponding garment has been washed, with various substances, and the combination of two separately controllable functionalities into one textile fabric finished according to the invention is made possible;
ii) functional surfaces (guest/host systems) are realized on textile fabrics, which make it possible to absorb predominantly lipophilic-dominated active ingredients as the guest substances, and release the latter again isotropically to the surrounding medium or anisotropically via a locally directed flow of substance into an immediately adjacent layer, depending on the intended application.

In order to realize the finishes according to the invention, both existing methods and methods new to textile finishing can be used, e.g., UV curing of the finish formulations applied to the textiles.

The finishes according to the invention can be designed and used as active ingredient release coatings, or so-called “drug delivery systems”, and/or as harmful ingredient uptake layers.

One essential feature of the invention is the application of finishes or finish layers onto textile fibers or fabrics which follow the guest/host principle, and offer a host system that has the broadest range of application possible, and can be repeatedly and temporarily loaded with the various active ingredients or guest molecules. The host layer applied by the textile finisher is the carrier for the guest molecules, which can be applied by the customer himself, for example. The customer (e.g., the manufacturer of ready-to-wear clothing, the chemical cleaner or the wearer) can hence as a rule determine the functionality of the respective fabric or garment himself. This is made possible through the use of cross-linkable polymer binders in combination with cross-linkable spacer substance, the use of a surfactant (emulsifier, disperser or mixtures thereof) and a general, multifunctional cross-linking agent, as well as the use of any catalysts. After fixed on the fiber or fabric surface, a finish layer consisting of such chemicals forms the host system necessary for receiving the active substances.

The swelling capability of the generated finishes is important in terms of understanding this invention. The use of preferably lipophilically modified polymer compounds and cross-linkable “tentacle” or spacer molecules gives rise to a polymer layer than can be swelled via polar-protic and/or polar-aprotic substances. When this polymer layer swells, stochastic nano-pockets (spatial expansions related to molecular size and dependent on the used spacers) form in the finish layer. These nano-pockets can receive one or more guest molecules, since their spatial structure and polarity can be adjusted to the molecular sizes of the guests to be received. The nano-pockets preferably have a maximum size of 500 nanometers. The one or more guest substances, i.e., the received active substances, are released again and desorbs when the fabric finished in this way is worn, assisted by body heat, moisture, friction and movement. Depending on the type of active substance, they can be absorbed by the skin of the wearer cutaneously or percutaneously, and exert the desired effect at the intended location.

The simultaneous use of cross-linkable surfactants yields a spatial, thermodynamically induced self-organization of the finish components, which determine the affinity of the layer relative to the predominantly lipophilic active substances on the one hand, and the physiological behavior of the finish layer relative to human skin on the other.

Immediately following the production of the finish layer, the nano-pockets are present in the non-swelled finish layer in a so-called collapsed form. The formation of nano-pockets that are potentially present after fixing the finish first takes place in contact with moisture and the substance to be sorbed, or the substance mixture to be sorbed, which can be an aqueous emulsion of the active substance to be absorbed or a mixture of active substances in a preferred embodiment. Both the quantity ratios and selection of chemicals that form the polymer layer represent control parameters for receiving and depositing active substance through the finish layer.

In addition to the nano-pockets, the finish layers according to the invention can be provided with micro- and/or meso-pores as additional structures. To this end, for example, CO₂ or N₂-separating substances can be mixed in while manufacturing the finish formulation, and/or non-reactive, evaporable solvents are added. The released gas or escaping non-reactive solvent yields a micro- or meso-capillarity (percolation cluster) in the finish layer during the drying and/or fixation process, wherein the size of the micro- and meso-pores ranges from 1 to 25 μm. The effective surface greatly enlarged in this manner influences the sorption or desorption behavior of the active substances to be applied significantly.

Another essential feature of the functional finishes manufactured in this way is the ability to repeatedly load the finish layer and its dynamic formation of nano-pockets specific to the active substances. This function is determined first and foremost by the type and concentration of the spacer substances present in the finish layer.

Another functionality of the finishes according to the invention can be achieved by mixing cage molecules into the finish formulation, or by separately applying the cage molecules on the reloadable textile according to the invention already provided with a polymer layer incorporating nano pockets [translator's note: sentence a bit strange in German; word may be missing]. In addition to the known cyclodextrins, special mention must be made of β-glucan and zeolites. The β-glucan is a polysaccharide structural polymer, which is formed as a waste product during yeast preparation. After removing the fat and protein substances from the glucan product, the glucan must be used as a cage molecule. Zeolites are water-containing structural silicates, which can hold various cations in their lattice structure on the one hand, and hold guest molecules in the interstices between the zeolite particles on the other.

The two host systems (dynamic formation of nano-pockets and cage molecules) are differentiated with respect to the receiving of different active substances via the component ratio of the finish layer that forms the nano-pockets on the one hand, and by the functional and constitutional properties of the used cage molecules and their interaction with the finish component on the other. For example, the charge dominance (anionic, non-ionic, cationic) of the cage molecules in conjunction with the used finish components influences its ability to absorb active substances. These parameters determine the priority sorption or desorption-determining properties for the guest molecules, such as polarity, affinity, geometric and spatial structures, etc.

In addition to the correct selection of finish chemicals and their mixing ratios, the drying and fixation conditions geared toward the chemicals that comprise the host are of significant importance for the formation of the nano-pocket structure of the host system. The chemicals forming the host are mixed together in a first step to yield a dressing liquor or finishing formulation. To this end, a main component is provided in the form of at least one polymer compound, which preferably consists of a cross-linkable, fat-modified (C₂ to C₁₈), water-emulsified acryl, epoxy or urethane polymer. Chemicals are then added as the spacers, which contain molecular “tentacles” with at least one terminal reactive group on the one hand, and perform spacer functions on the other. The chemical constitution of the molecular “tentacles” or spacers comprises polyether chains, for example, preferably polyoxyethylene, polyoxypropylene, block polymers, and/or C₂ to C₁₈ chains, e.g., with terminal hydroxyl, amino, carbonyl, carboxyl, acid amide, isocyanate, N-methylol or methoxy-N-methylol functions (α-aminoalkylation products).

At least one multifunctional artificial resin compound is preferably added to the dressing liquor as another component to act as cross-linking agent (α-aminoalkylation products, e.g., methoxylated ethylene carbamide or melamine compounds), which play a crucial role in helping to determine washing resistance, swelling capability and the nano-pocket structure of the finish layer.

Catalysts are used as substances that catalyze the cross-linking of ingredients, e.g., magnesium chloride, mono- and polycarbonic acids or esters as acid-separating compounds.

In order to control the affinity and physiological behavior of the finish layer, a surfactant or mixture of surfactants is incorporated into the liquor. Surfactants are typically anionic and nonionic substances, such as glyceryl citrate, glyceryl laurate, fat-modified sorbitan derivatives (e.g., emulsifiers from the span and tween series), cetaryl glucosides, polyglyceryl oleates, polyglyceryl stearates as well as siloxane polyglycolether and/or siloxanpolyglucosides, the HLB values (hydrophilic-lipophilic balance) values for which range from 3 to 15.

Gas-separating (CO₂ and N₂ as blowing gases) and non-reactive substances that have a swelling effect on the finish layer are used optionally for specific purposes, e.g., when high peak charges and high release rates are required. This objective is closely correlated with the sorption and desorption of undesired odiferous substances. A desired micro/mesoporous percolation structure for the finish layer is achieved by adding organic CO₂ and N₂-separating blowing gas substances (e.g., acetoacetic acid, 2,2′-azobis-isobutyronitril, 2,2′-azobis-(2-methylpropane), inorganic CO₂-separating substances (e.g., sodium hydrogen carbonate in combination with acid-separating catalysts) along with polar, non-reactive, swelling solvents (e.g., ethyl acetate, methylglycolacetate, diglycol dimethyl ether), the boiling point of which ranges from 60 to 200° C., preferably measuring 120° C.

In a second procedural step, the dressing liquors containing the host chemicals are applied to the textile article using standard industrial application techniques, e.g., pad-dying, coating or spraying. In order to increase the washing permanence of the host system, reactive group-containing adhesive layers, also called primer layers, can be applied beforehand, especially for synthetic fiber materials. These primer layers are known from WO 01/75216, for example. The application of primer layers is a procedural step that precedes the host layer application. Depending on the intended application for the fabric carrying the host layer, universally applied application systems, e.g., stop padding, can be used to apply two host layers that exert different actions, e.g., differing in their affinity (more or less lipophilic).

The third procedural step of importance for generating the nano-pocket structure involves drying the impregnated fabric (residual water content up to 30%), and then fixating the finish layer, which can be done using both a dry-fixation process (at 120 to 180° C.) and a moist-fixation process (at 15 to 40° C.). The finished fabric is dried at temperatures of between 50 and 150° C. for 30 to 180 seconds using industrial machinery, such as tentering frames or hotflue. While fixing the finish layer, thermal and/or UV radiating reaction apparatuses are preferably used, depending on the polymer/cross-linking system employed. Thermal fixation takes place at temperatures of between 120 and 200° C., preferably at 140 to 160° C., and reaction times of 1 to 5 minutes. When using UV-cured polymers, reaction times of 0.5 to 60 seconds, preferably 1 to 3 seconds, are necessary, depending on the polymer type and radiated power of the reaction aggregate. The major advantage to using UV-cured polymers is the wash-resistant layer fixation on the textile substrate that can occur at low temperatures. As a result, the functional layer can be loaded with an active substance as the layer-forming chemicals are being applied, even without the otherwise common thermal breakdown reactions and/or evaporation of guest substances.

The following cases illustrate selected examples for a preferred finish formulation, manufacture of the nano-pocket-forming finish layers according to the invention, and their efficiency relative to the desired functionality.

### EXAMPLE 1

### Finish Layer for Generating Nano-Structured Percolation Clusters

A pre-cleaned and bleached mixed cotton fabric (75% Co, 25% PES) with a square meter weight of 210 g/m² is impregnated with a finish liquor, the components of which form nano-pockets, i.e., nano-structured percolation clusters, during the drying phase of the fabric. The non-pocket-containing fabric coating can be used both as a reloadable drug delivery system and a pure sorption layer, e.g., for undesired odoriferous materials.

The finish formulation applied to the fabric surface has a mass fraction of 11% relative to the dry fabric weight. After the fabric has been impregnated with the liquor containing the finish components, the fabric is dried for 120 seconds at 120° C.

The finish formulation contains the following components:

TABLE 1
Finish formulation according to Example 1

| Liquor components | Concentration | |
|---|---|---|
| Water | 786.5 | |
| Dicrylan AS | 150 | g/l |
| Glucan P20 | 45 | g/l |
| Lyofix CHN | 12.5 | g/l |
| Magnesium chloride | 6 | g/l |

Dicrylan AS is an aqueous 40% acrylate dispersion sold by ERBA, and yields a soft, hypoallergenic coating when combined with the other formulation components. Glucan P20 is a cross-linkable propoxylated glucose, and serves as a spacer to form the nano-pockets that the host system generates for the active agents (guests) to be applied later.

Lyofix CHN is an artificial resin (partially etherized hexamethylol-melamine resin) that cross links the finish components, and yields a wash-permanent fabric coating when combined with the other formulation components and the catalyst (MgCl₂).

The layer is fixed at 150° C. for 3 minutes.

When immersed into an aqueous emulsion containing the active substance or active substances, the layer fabricated in this way is able to form the nano-structured percolation cluster loaded with active substance(s).

### EXAMPLE 2

### Nano-Pockets with Dynamic Adjustment to Guest Substances

A boiled and bleached mixed fabric consisting of 30% cotton and 70% polyamide and having a square meter weight of 165 g has applied to it via impregnation a finish formulation, also referred to as coating mass below, and representing the host system for the gust substances (i.e., active substances) to be applied after production of the fabric. The finish fixated on the fiber surface has a mass fraction of 8% relative to the dry weight of the untreated fabric. After impregnating the mixed fabric with the finish liquor containing the coating mass, the fabric is dried for 60 seconds at 130° C., and the finish layer containing the nano-pockets that forms in the drying process is fixated at 150° C. for 180 seconds. The impregnation liquor contains the following components:

TABLE 2
Finish formulation according to example 2

| Liquor components | Concentration | |
|---|---|---|
| Water | 799.4 | g/l |
| Subitol ES | 3 | g/l |
| Dicrylan AS | 104 | g/l |
| Ethyl-hydroxyethylcellulose | 7 | g/l |
| Pluriol P 600 | 30 | g/l |
| Lauryl sorbitan | 10.6 | g/l |
| Lyofix MLF | 36 | g/l |
| Magnesium chloride | 8 | g/l |
| Citric acid | 2 | g/l |

Subitol ES (Bezema AG) is a cross-linking and blocking aid based on anionic surfactants. DICRYLAN AS is a chemically/thermally cross-linkable nonionic polyacrylate dispersion for the aqueous coating of textile fiber materials.

Pluriol P 600 (BASF) is a polypropylene glycol with an average molar mass of approx. 600 g/ml, and is used to suppress foam and impart solubility, change polarity and alter consistency.

LYOFIX MLF (ERBA) is a nonionic, relatively low-formaldehyde, partially etherized hexamethylolmelamine resin for dimensionally stable finishes on cellulose and mixtures thereof with synthetic fibers. By comparison to conventional cross-linking agents based on melamine, it has a lower formaldehyde content, and a high buffering effect, and results in good washing and ironing/shrinkage values, good primary effects and very good permanence.

After twelve hours of exposure to an aqueous emulsion with 20% isooctanol as the model substance for lipophilic wellness substances, the finish layer yielded by this finish liquor exhibits up to a 16% octanol absorption relative to the layer mass. After loading and extracting the finish layer three times with a 50% water/ethanol solution, the originally determined 16% octanol uptake could be reproduced.

This experiment showed that even the end consumer can repeatedly load the finish layer with lipophilic substances, wherein he can freely select the functionality of the finish layer to reflect his needs.

### EXAMPLE 3

### Functionalized finish with Nano-Pockets for Neurodermatitis Patients

A knitted fabric comprised of polyester and lycra with a square meter weight of 230 g is chemically cleaned to remove fiber preparations before dying, and then dyed. An application system that coats one side (stop padding technique) on the back of the knitted fabric and subsequent garment is used to apply a coating mass to the dyed and dried knitted fabric, wherein the coating mass is capable, as the host system, of absorbing lipophilic active substances, such as phenol carbonic acids of an oregano or burdock root extract, farnesol or gamma-linolenic acid (evening primrose oil), as the guest. The functionality of the finish layer is only determined by the person wearing the garment by the selection of active ingredient to be applied. The oregano and burdock root extract involve the fungicidal and bacteriostatic effect, while farnesol involves only the bacteriostatic effect, and the evening primrose oil eases itching of the skin triggered by neurodermatitis. The nano-pocket-containing coating layer is manufactured by impregnating the knitted fabric with the finish liquor described below, followed by drying at 120° C. for 80 seconds, and fixation at 160° C. for 180 seconds. The mass of the applied finish layer measures 12% relative to the dry weight of the knitted fabric. The layer components and their concentrations are listed below.

TABLE 3
Finish formulation according to example 3

| Liquor components | Concentration | |
|---|---|---|
| Water | 717.5 | g/l |
| Invadin PBN | 2.5 | g/l |
| Perapret HVN | 120 | g/l |
| Ethyl-hydroxyethylcellulose | 10 | g/l |
| Pluronic PE 3100 | 39 | g/l |
| Drapal GE 202 | 42 | g/l |
| Lyofix MLF | 54 | g/l |
| Magnesium chloride | 15 | g/l |

Invadin PBN (ERBA) is a surface-active preparation consisting of ethoxylated fatty alcohol and aliphatic ether alcohol, and is used as a special cross-linking agent for water and oil-repelling finishes.

Perapret HVN is an anionic, thermally cross-linkable polyacrylate dispersion offered by BASF for finishing wovens or knitwear comprised of cellulose fibers and mixtures thereof with synthetic fibers.

Pluronic PE 3100 is a BASF product manufactured via the copolymerization of propylene oxide and ethylene oxide, which is used as a low-foam surfactant.

Drapal GE 202 (Akzo Chemie) is a partially esterified, branched carbonic acid copolymer with hydrophobic alkyl and hydrophilic ether groups with emulsifying properties.

LYOFIX MLF (ERBA) is a nonionic, relatively low-formaldehyde, partially etherized hexamethylolmelamine resin for dimensionally stable finishes on cellulose and mixtures thereof with synthetic fibers. By comparison to conventional cross-linking agents based on melamine, it has a lower formaldehyde content, and a high buffering effect, and results in good washing and ironing/shrinkage values, good primary effects and very good permanence.

The finish layer fabricated according to the above formulation was loaded with an aqueous oregano or burdock root extract and farnesol-containing emulsion by unilaterally spraying the side of the knitted fabric bearing the coating layer. After twelve hours of exposure, a piece of knitted fabric was subjected to gentle washing and dried. A washed section of knitted fabric containing the active ingredients and an untreated knitted fabric section were then placed on agar gel attacked by mold, and left in a conditioning cabinet for three days at 30° C. After three days, the untreated knitted fabric section was largely overgrown by the mold culture, while the knitted fabric section bearing the finish and loaded with burdock root extract and farnesol completely stopped mold growth on the agar layer covered by the specimen via the desorption of the active substances.

This example demonstrates the loading of the host layer and the desorption of the guest substances that exert a fungicidal and bacteriostatic effect in this case as a function of the intended application.

### EXAMPLE 4

### Finish with Odor-Absorbing Effect

After pre-washed, a mixed fabric consisting of 30% cotton and 70% polyester is dyed and dried. The fabric surface is functionalized by applying a finish layer having the composition specified below:

TABLE 4
Finish formulation according to example 4.

| Liquor components | Concentration | |
|---|---|---|
| Water | 747 | g/l |
| Subitol LS-N | 3 | g/l |
| Dicrylan AS | 120 | g/l |
| Methocell 311 | 12 | g/l |
| Polypropylene glycol | 30 | g/l |
| Siloxane polyglycol ether | 8 | g/l |
| Knittex FPC | 55 | g/l |
| Knittex catalyst MOF | 10 | g/l |
| Azobisisobutyronitrile | 15 | g/l |

Subitol LS-N is an anionic, low-foam cross-linking agent based on a synergistic surfactant mixture, and is sold by the company CHT in Tübingen.

Methocell 311 is a cellulose ether made by DOW Europe S.A.

Knittex FPC (ERBA) is a nonionic reactant cross-linking agent based on a modified glyoxal cross-linking agent for the low-formaldehyde, boil wash-resistant, easy-care finishing of cellulose articles and mixtures thereof.

Knittex catalyst MOF (ERBA) is a magnesium salt-based liquid acid donor, which is preferably used for applying a high-grade finish to cellulose articles. Azobisisobutyronitrile is used as an N₂-separating swelling agent.

The chemicals contained in the finish liquor ensure the formation of a nano-pocket structure and polarity suitable for absorbing lipophilic substances on the one hand, and the layer porosity necessary for the rapid sorption and desorption of the sorbents on the other. To fabricate the functional layer, the fabric is impregnated with the finish liquor described above (liquor absorption 80%) and dried at 110° C. for 180 seconds. The layer is subsequently fixated via condensation on a tentering frame at 150° C. for 3 minutes. To prevent the otherwise common exposure of the sorbed substances to bacteriological attack, the finish layer is loaded with a little farnesol (approx. 2% relative to the weight of the finish layer).

After loaded with farnesol, the finish described in Example 4 is used to sorb odor-intensive substances, e.g., the kind encountered at restaurants or in restaurant kitchens. The occupational clothing for restaurant personnel provided with the finish according to Example 4 or this type of women's or men's outer clothing is unencumbered by any odor even after worn three days. The described odor absorption properties of the farnesol are retained even after the garments have been washed repeatedly, wherein the garment or finish layer must be loaded with farnesol after each wash.

### EXAMPLE 5

### Bi-Component Finish with Nano-Pockets and Cage Molecules

A knitted fabric consisting of 100% polyamide is dyed and dried after removing fiber softeners. The knitted fabric is subsequently impregnated in a first step with the chemicals that form the nano-pockets, and dried at 120° C. for 2 minutes. In a second procedural step, a suspension containing an anionic glucan modified via carboxylation (cage molecule) is applied via unilateral stop padding, wherein the cage molecule was loaded with a silver complex beforehand. This was followed by drying and chemically fixating the two host systems (nano-pockets and cage molecules), the functionalities of which differ owing to the varying charge dominance (non-ionic nano-pocket host and anionic cage molecule host). The nano-pocket-forming finish mass applied to the knitted fabric makes up 10%, and that of the loaded glucan makes up 1%, relative to the untreated knitted mass. The ingredients in the dressing liquor applied in a first procedural step with a residual moisture of 72% are listed below:

TABLE 5
First finish formulation according to example 5

| Liquor components | Concentration | |
|---|---|---|
| Water | 780 | g/l |
| Subitol ES | 2.5 | g/l |
| Dicrylan AS | 140 | g/l |
| Bermocoll E 230 FQ | 5 | g/l |
| Pluronic P 3500 | 23 | g/l |
| Lyofix MLF | 30 | g/l |
| Drapal GE 202 | 10 | g/l |
| Magnesium chloride 6H₂O | 8 | g/l |
| Citric acid | 1.5 | g/l |

BERMOCOLL E 230 FQ (Akzo Nobel) is a nonionic, water soluble cellulose ether (low viscosity grade of ethyl hydroxyethyl cellulose) that increases the consistency and stability of water-based products.

Pluronic P 3500 (BASF) is a block polymerizate of polypropylene glycol and ethylene oxide, and is primarily used as a nonionic surfactant.

The glucose suspension unilaterally applied in the second procedural step on the subsequent bearing side of the garment via stop padding consists of the following:

TABLE 6
Glucan-containing second finish formulation
according to example 5

| Liquor components | Concentration | |
|---|---|---|
| Water | 964 | g/l |
| β-glucan (anionically modified | 25 | g/l |
| and loaded with silver complex) | | |
| Glutardialdehyde | 8 | g/l |
| Acetic acid 80% | 1 | g/l |
| Subitol ES | 2 | g/l |

This finish reflects a multifunctional layer for articles of clothing worn next to the skin, wherein the wearers have dry, scaly or easily infected skin. It has the pronounced bactericidal function of the silver-loaded glucan cage molecules, and the skin is also relubricated and moisturized by the active ingredients loaded in the nano-pockets, yielding a bacteriostatic effect. To this end, the functional layer containing the nano-pockets was loaded for twelve hours with an aqueous emulsion containing linseed oil, carbamide, gamma-linolenic acid and farnesol, and the deposition was examined for several days on a gel that simulates the human skin. After a four-day desorption of the mentioned active substances in a Franz diffusion cell, only approx. 17% of the active substance mass originally present in the nano-pocket structure could be detected. As expected, the remaining 83% of the active substance mass was in the diffusion gel simulating human skin.

Based on the described multifunctionality of the finish layer, its use in clothing worn close to the skin is absolutely ideal for neurodermatitis patients.

### EXAMPLE 6

### Other Bi-Component Finishes with Nano-Pockets and Cage Molecules

After pre-cleaned, a knitted fabric consisting of 100% polyamide is dyed, rinsed and subjected to post-treatment with tannin. In a first step, the dried knitted fabric is finished with the chemicals forming the nano-pockets similarly to Example 5. In a subsequent procedural step, a suspension of silver zeolite is sprayed on. The subsequent drying and condensation now fixate the two host systems (nano-pockets and silver zeolite) on the knitted fabric. The amounts applied were selected similarly to the amounts prescribed in Example 5. The chemicals applied in the first procedural step were applied with a residual moisture of 75%. The silver zeolite-containing liquor sprayed on the knitted fabric consists of the following:

TABLE 7
Silver zeolite-containing finish formulation
according to example 6

| Liquor components | Concentration | |
|---|---|---|
| Water | 956.5 | g/l |
| Silver zeolite | 30 | g/l |
| Acryl polymer | 12 | g/l |
| Subitol ES | 1.5 | g/l |

The functionality of the finish layer consisting of two host systems can be attributed to the intended application mentioned in Example 5. Using zeolites that are not loaded or loaded with other substances (than the silver) makes it possible to generate other functionalities.

In the case of thermally and/or UV or blue light-cured finishes, the host system for receiving active ingredients and active substances (guests or drugs) consists of thermally and/or UV or blue light-cured prepolymers or monomers, as well as at least one component with a spacer function and a surfactant. A host system structured in this way can be swelled by aqueous emulsions containing active ingredients and active substances, and is able to sorb and again release the active ingredients and active substances contained in the emulsions.

The surfactants are reactive group-containing monomers and/or polymers having an HLB value fluctuating between 3 and 16, preferably between 8 and 12. Typical ones include sorbitan laurate or stearate, mono and diglycerides, ethoxylated and/or propoxylated C₈-C₂₀-compounds or vinyl or allyl-ether alkoxylates with 10 to 30 EO units, which form addition or condensation products with predominantly nucleophilic reactive groups, e.g., amino and hydroxyl functions.

The spacer substances that help determine the swelling of the finish layer are of a general type: RG-RS-RG. RG corresponds to a UV or blue light-cured reactive group or a functional group that cross-links with such a reactive group, and RS corresponds to a residue characterizing the spacer substance, e.g., a polyether, polyester or vinylog chain.

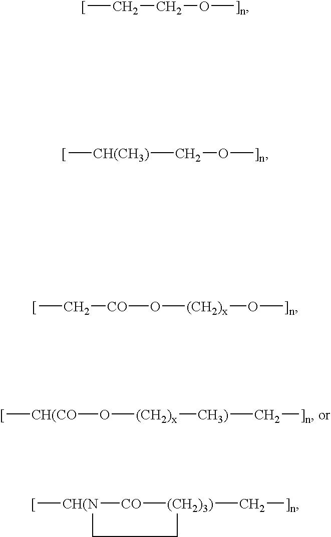

The chain length of the residual RS determining the hydrophilia or hydrophobia of the spacer substance is defined by n and x, wherein n is preferably greater than 5 and less than 30, and x preferably lies between 2 and 4.

### EXAMPLE 7

### UV Cured, Bacteriostatic Finish

After pretreated (desizing and bleaching), a fabric consisting of cotton and polyester with a square meter weight of 170 g is dyed and dried. The fabric is subsequently impregnated with wellness active ingredients and the coating components forming the “micro-pockets”, the chemical fixation of which only takes place after the fabric has been dried via UV curing. The use of UV curing, nano-pocket-generating finish components makes it possible to already use wellness active substances while manufacturing the finish layer, without having to worry about its chemical alteration or thermally induced substance losses.

The following formulation for a finish with bacteriostatic effect illustrates such an example:

TABLE 8
UV-curable, bacteriostatic finish
formulation according to Example 7

| Liquor components | Concentration |
|---|---|
| Water | 77.7% |
| Emulsoge R 109 | 1.5% |
| Dicrylan AS (40%) | 10% |
| OTA 480 | 6% |
| Methacrylic acid-octadecyl ester | 4% |
| 2-hydroxy-2-methyl-1-phenyl | 0.3% |
| 1-propane | |
| Farnesol | 0.5% |

The finish liquor is applied to the fabric by means of a foulard, with a pinch-off effect of 75%, and dried in a tentering frame at 110° C. for 2 minutes. Immediately after passing through the tentering frame, the finish layer is subjected to UV curing. Layer curing lasts for 2.5 seconds in the UV channel under a protective atmosphere.

The fabric finished in this way is characterized by a slightly hydrophobic and bacteriostatic action. The bacteriostatic action can be reloaded again with farnesol after the garment in question has been washed.

### EXAMPLE 8

### UV-Curable, Reloadable Finish Coat

A pre-cleaned, dyed polyamide fabric with a square meter weight of 180 g/m² is impregnated with a solution of 5 g/l Rewin RT (BEZEMA AG) to improve colorfastness. The pretreated and dried fabric is impregnated in a second step with a finish formulation in the form of an aqueous emulsion on a tentering frame foulard. The manufacture and composition of the emulsion is described below.

The emulsion is manufactured with the following components:

TABLE 9
UV curable finish formulation according to example 8

| Liquor components | Concentration (in % w/w) |
|---|---|
| Water | 93.0 |
| Superonic PE/F108 | 1.40 |
| OTA 480 | 2.10 |
| UVR 6105 | 1.61 |
| Pluronic PE 6200 | 1.05 |
| Ethylhydroxyethyl cellulose | 0.21 |
| Sorbitan monolaurate | 0.35 |
| 2-hydroxy-2-methyl-1-phenyl | 0.28 |
| 1-propanon | |

OTA 480 is a propoxylated trimethylol propane-triacrylate, and sold by UCB. Superonic PE/F 108 is a vinyl ether alkoxylate (approx. 14,000 g/mol) from Unicema. UVR 6105 denotes an epoxy resin from Dow.

Water and Superonic PE/F 108 are thoroughly mixed together. The mixture of OTA 480, UVR 6105, Pluronic PE 6200, ethylhydroxyethyl cellulose, sorbitan monolaurate and 2-hydroxy-2-methyl-1-phenyl-1-propanon is added to this mixture in small portions.

The fabric impregnated on the tentering frame foulard with a liquor application of 80% relative to the dry weight of the textile article is subsequently dried at 120° C. for 2 minutes, and after drying passes through a UV channel to fixate the finish layer. The reaction time in the UV channel measures 2.5 seconds at a specific radiated power of 5.5 kW/m². The UV channel is preferably flushed with a protective gas like nitrogen, CO₂ or argon, in order to avoid any undesired oxidation processes during the radical curing of acrylates on the one hand, and prevent ozone formation on the other.

The fabric finish manufactured in this way is distinguished by excellent host properties, which in turn are characterized by the good swelling capability of the host layer and the high affinity to lipophilic substances. The layer fabricated in the described manner exhibits a specific substance absorption of 23 mg isooctanol (model substance for therapeutic and/or cosmetic active substances) per gram of host layer. Another essential host property criterion is the reloading of the host layer after the respective article of clothing has been washed. The reloadability of the finish layer still measures 82% of the original sorption capacity for isooctanol after five washes.

In addition to the properties relating to the functionality of the UV-curable finish layers, mention must be made of their cost-effective manufacture, since the high-temperature fixation that normally takes place is omitted. The use of UV-curing finish components makes it possible to use or add the desired active substances already while manufacturing the finish layer, without having to worry about its chemical alteration or thermally induced substance losses.

1. (canceled)

2: The finish formulation according to claim 46, wherein the polymer binder is selected from the group consisting of: cross-linkable, fat-modified, water-emulsified, C₂ to C₁₈ acryl-, epoxy-, vinyl acetate-, vinyl pyrolidone polymers and their block polymers or urethane polymers.

3: The finish formulation according to claim 46, wherein the polymer binder is present in a percentage of 40 to 80% relative to the dry substance content of the finish layer to be manufactured.

4: The finish formulation according to claim 46, wherein the cross-linking agent is a multifunctional artificial resin compound selected from the group consisting of: α-aminoalkylation products, methylolated and/or methyoxylated ethylene carbamide, and melamine compounds.

5: The finish formulation according to claim 46, wherein the cross-linking agent is present in a percentage of 5 to 40% relative to the dry substance content of the finish layer to be manufactured.

6: The finish formulation according to claim 46, wherein the spacer substance is selected from the following group: polyether chains, polyoxyethylene, polyoxypropylene, block polymers and/or C₂ to C₁₈ chains with terminal hydroxyl-, amino-, carbonyl-, carboxyl-, acid amide-, isocyanate-, N-methylol- or methoxy-N-methylol functions.

7: The finish formulation according to claim 46, wherein the spacer substances are present in a percentage of 5 to 40% relative to the dry substance content of the finish layer to be manufactured.

8: The finish formulation according to claim 46, further comprising a cross-linking catalysts selected from the group consisting of: magnesium chloride, mono- and polycarboxylic acids or esters.

9: The finish formulation according to claim 46, wherein the cross-linking catalyst is present in a percentage of 1 to 8% relative to the dry substance content of the finish layer to be manufactured.

10: The finish formulation according to claim 46, wherein at least one anionic or nonionic substances with an HLB value between 3 to 15 is added as surfactants, the latter being selected from the following group: glyceryl-citrates, glyceryl-laurates, fat-modified sorbitan derivatives, emulsifiers from the span and tween series, cetaryl glucosides, polyglyceryl oleates, polyglyceryl stearates, siloxane polyglycolether and siloxanpolyglucosides.

11: The finish formulation according to claim 46, wherein the surfactants is present in a percentage of 2 to 25% relative to the dry substance content of the finish layer to be manufactured.

12-15. (canceled)

16: The finish formulation according to claim 46, wherein the formulation encompasses cage molecules from the group consisting of cyclodextrins, dendrimers and glucans.

17: The finish formulation according to claim 16, wherein the cage molecules are present in a percentage of 1 to 20% relative to the dry substance content of the finish layer to be manufactured.

18: The finish formulation according to claim 46, wherein the formulation can be cross-linked by light in the UV range of 100 nm to 400 nm, or in the visible range of 400 nm to 800 nm.

19. (canceled)

20: A finish for textile fibers and fabrics, wherein the finish is fabricated using the finish formulation according to claim 46, and can be swelled by polar-protic and/or polar-aprotic substances, and that, in a swelled state, exhibits nano-pockets that can be repeatedly loaded with active substances.

21: The finish according to claim 20, wherein the nano-pockets exhibit a stochastic distribution with respect to their spatial expansion.

22: The finish according to claim 20, wherein the upper limit to the size of the nano-pockets lies at 500 nm.

23: The finish according to claim 20, wherein the finish exhibits a micro- or meso-capillarity, and the size of the micro- and meso-pores ranges from 1 to 25 μm.

24: The finish according to claim 20, wherein the finish encompasses cage molecules selected from the group consisting of cyclodextrins, dendrimers, glucans and mixtures thereof.

25: The finish according to claim 20, wherein the finish encompasses silver zeolite.

26: A method for manufacturing a finish on a textile fiber or fabric wherein at least one finish formulation according to claim 46 is applied to the textile fiber or fabric.

27: The method according to claim 26, wherein the finish formulation is applied to the textile fiber or fabric using standard industrial application techniques, and then dried and fixed.

28: The method according to claim 27, wherein the fiber or fabric is dried at temperatures of between 50 and 150° C. for 30 to 180 seconds using conventional industrial machinery.

29: The method according to claim 27 thermal and/or UV or blue light-radiating reaction apparatuses are used when fixing the finish layer.

30: The method according to claim 27, wherein thermal fixation takes place at temperatures of between 120 and 200° C.

31: The method according to claim 29, wherein chemical fixation takes place after the fiber or fabric has been dried via UV- or blue light-curing.

32: The method according to claim 31, wherein light in the UV range of 100 nm to 400 nm or in the visible range of 400 nm to 800 nm is used for fixation.

33. (canceled)

34: The method according to claim 31, wherein the active substances are already added to the finish components prior to fixation.

35-37. (canceled)

38: A textile article comprising: (a) a carrier material selected from a group encompassing textile fibers and fabrics, and (b) a finish according to claim 20 applied to the carrier material.

39: A textile article having at least one side provided with a finish according to claim 20.

40: The textile article according to claim 39, wherein a second side is provided with a finish comprising a cage molecule selected from the group consisting of: cyclodextrins, dentrimers, glucans and mixtures thereof.

41: The textile article according to claim 40, wherein a second side is provided with a finish that comprises silver zeolite.

42: The textile article according to claim 39, wherein the article can be repeatedly loaded with at least one active substance.

43. (canceled)

44: The textile article according to claim 42 wherein the at least one active substance is selected from the group consisting of: phenol carboxylic acids of an oregano or burdock root extract, farnesol, gamma-linolenic acid (evening primrose oil), lipophilic analgesics, hormones, vitamins, scopolamine, cinnarizine, meclozine, nicotine, heparin, antihistamine, diclofenac, and glycerol trinitrate.

45: The textile article according to claim 39, wherein the mass of the applied finish layer measures between 1 and 10% relative to the dry weight of the textile.

46: A formulation for manufacturing a finish layer on a textile fiber or fabric, comprising:
(a) a cross-linkable polymer binder;
(b) a surfactant;
(c) a multifunctional cross-linking agent; and
(d) a cross-linkable spacer substance,
wherein the formulation may be used to manufacture a finish layer having nano-pockets that can be swelled by a polar-protic or polar aprotic substance and that can be repeatedly loaded with an active substance.
